(19) United States
(12) Patent Application Publication
(10) Pub. No.: US 2009/0092283 A1
(43) Pub. Date: Apr. 9, 2009

(54) SURVEILLANCE AND MONITORING SYSTEM

(75) Inventors: Rand P. Whillock, North Oaks, MN (US); George A. Kilgore, Colorado Springs, CO (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/869,485

(22) Filed: Oct. 9, 2007

(51) Int. Cl. G06K 9/00

(52) U.S. Cl. 382/103; 382/115; 340/5.1; 340/5.82

(57) ABSTRACT

A system having one or more devices for detection, surveillance and monitoring. Video images of scenes with persons from the devices may be processed and provided to a biometrics component for standoff biometric acquisition and matching. Various remote and internal databases may be resorted to for biometric matching. Matching results may go to the history component and the strategy and association component. The output of the latter component may be subject to behavior inference and analysis. The system may be interconnected with outside entities such as an access control system.

### BACKGROUND

The invention pertains to surveillance systems particularly to biometric-based surveillance systems.

### SUMMARY

The invention is an individual and group interaction pattern and association detection, surveillance and monitoring system

### BRIEF DESCRIPTION OF THE DRAWING

FIG. 1 is a diagram of an automated video-based people and crowd social activity and cluster detection and surveillance system node; and

FIG. 2 is a diagram of a system having a number of system nodes of FIG. 1.

### DESCRIPTION

Video and audio surveillance of individual target areas, where people of interest are suspected to congregate, may be routinely used to record the timing of meeting events, the number of participants and their conversations. The basic functionality of these surveillance techniques may however be significantly enhanced by an addition of specialized long-range face and/or iris acquisition and recognition, and/or other remote biometric capabilities. Automated analytic capabilities may enable a wide range of new counter-terrorism and counter-espionage operative tracking and identification on a global scale. Analyst productivity, response time and workload efficiency may be greatly improved. Benefits derived from the present capabilities may include automated identification of leaders who are repeatedly seen to be a focus of group meetings, a focus of surveillance on participants that repeatedly assemble in view of suspicious circumstances, a rapid ability to determine identities of participants observed by surveillance, and a capability to link behavior patterns of persons in dispersed activities which are separated in time.

The addition of a remote biometric capture may facilitate tagging individual participant faces and irises seen in a surveillance video, including those of whose identities may not yet be known. An identity tag applied to a not-yet-recognized face and/or iris images captured may facilitate biometric “enrollment of the crowd” for later use in matching individuals in one place with the “same” persons seen at different times and other places. An assignment of participant identity tags to persons in the scene without their knowledge may allow tracks of their motion through the scene to be calculated. From these tracks, it is possible to analyze the convergences of individual behaviors that reveal a formation of pairs or sub-group clusters and thus a structure of the group's leadership and its key members. An analysis of patterns of social behavior and known group formation may allow suspiciously unusual conduct to be detected and used to direct the surveillance.

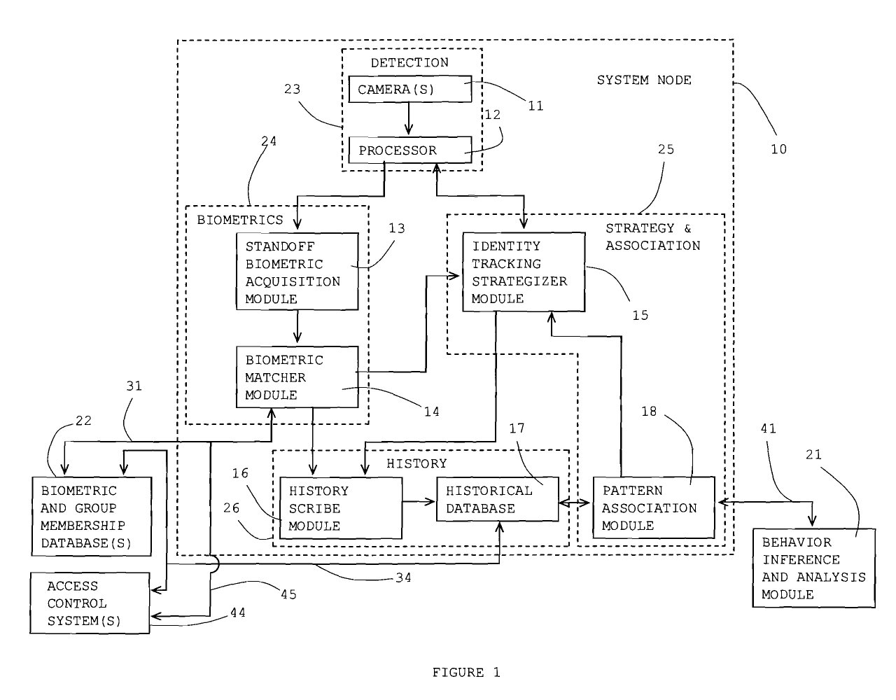

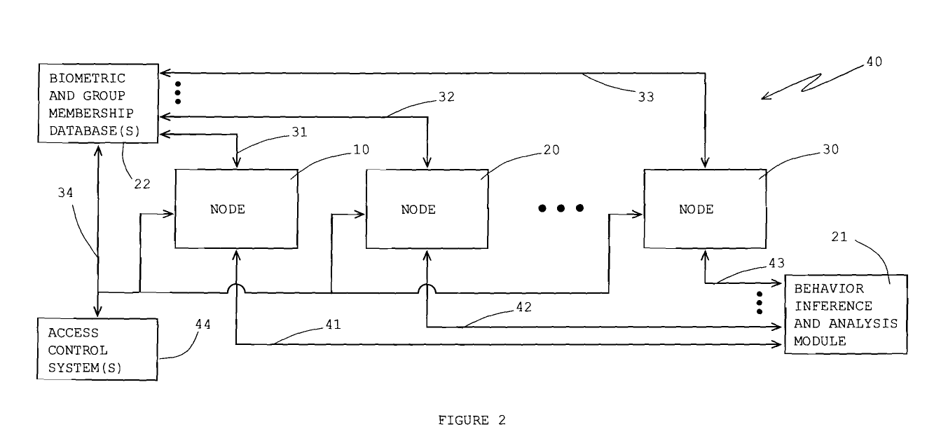

FIGS. 1 and 2 show major modules in an automated surveillance system to find, identify and track human subjects in the scene and then analyze subject social interaction patterns and group associations that establish membership in organized activities and permit interaction with behavior inferencing and analysis systems that may be available. The automated system may be a single surveillance system node as shown in FIG. 1 or the system may contain multiple cooperating surveillance system nodes that expand the surveillance area coverage and/or add additional perspectives to a designated area as shown in FIG. 2.

FIG. 1 is a diagram of a single node social activity and cluster detection, surveillance and monitoring system node 10. Major portions of system node 10 may include a detection component 23, a biometrics component 24, a strategy and association component 25, and a history component 26. The detection component 23 may include a camera or cameras 11 and a video or image processor 12. Processor 12 may provide other processing for the system node in addition to video or image processing. Processor 12 may connected to or tie in with other processors such as personal computers. The biometrics component 24 may include a standoff biometric acquisition module 13 and a biometric matcher module 14. The strategy and association component 25 may include an identity tracking strategizer module 15 and a pattern association module 18. The history component 26 may include a history scribe module 16 and a historical database 17.

The camera or cameras 11 may detect the presence of a person or persons in a scene transformed into a form of video signals which go to the processor 12. Processor 12 may determine the real world coordinate x and y positions of the person or persons in the scene. Also, the processor 12 may determine the face and body size, and range data from the video signals from camera 11. An output from the video processor 12 may go the standoff biometric acquisition module 13. Module 13 may provide face recognition, iris recognition and other surveillance biometrics information. This information may be provided to the biometric matcher module 14. Module 14 may calculate an identity match with the available biometric(s) and assign a unique temporary identification (ID) designation to each unknown person.

An output from the processor 12 may go to the identity tracking strategizer module 15. Also, an output from the biometric module 13 may go to the module 15. Module 15 may determine a range to a subject person. Module 15 may calculate velocity vectors and calculate the tracks of each person through the scene in terms of x, y and r, i.e., (x,y,r). If the connection or interaction between processor 12 and module 15 is two-way, then the tracking may include directing the camera 11 in terms of panning, tilting and zooming (PTZ), zooming to a face, doing autofocus, and so on. Additionally, the two-way connection between the processor 12 and module 15 may facilitate camera 11 array networking.

Outputs from the biometric matcher module 14 and the identity tracking strategizer module 15 may go to the history scribe module 16. Module 16 may calculate track convergence. It may cluster a unique temporary group ID, and maintain current membership. An output of the history scribe module 16 may go to the local historical database 17. The historical database 17 may provide prioritization for cluster monitoring, past cluster membership and current cluster membership dynamics. An output from database 17 may go to the pattern association module 18, and an output from module 18 may go to database 17. Module 18 may provide multiple cluster membership IDs and calculate a social structure of a cluster by watching the actions of individuals over time. Module 18 may allow prioritizations of previous or “key member” tracking and feedback such information to module 15. Information from module 18 may also go to a behavior inferences and analyses module 21 outside the system node 10 via a two-way connection 41. Module 21 may provide information about higher level behaviors to module 18. Module 21 may be referred to as a behavior inference and analysis module in that the term “inference” may mean one or more inferences and “analysis” may mean one or more analyses. Module 21 may receive data and information from module 18 for inference and analysis of information which may lead to or provide identification of groups and members, bases of concern about the groups and members, reasons warranting surveillance and monitoring of the groups and members, and the like.

Information from the biometric matcher 14 may go to biometric and group membership database or databases 22 outside the system node 10 via a two-way connection 31. The term “database”, as used herein, may be understood to mean database or two or more databases. Database 22 may include national asset databases, a local collection database and a local watchlist. Other kinds of information may be in the database 22. Also, information may be retrieved by module 14 from the database 22 for identity matching and other purposes. The historical database 17 may provide information to and retrieve information from the database 22. A two-way connection 34 between databases 17 and 22 may allow for group membership information to be added to the local historical database 17 and information from the historical database 17 may be exported to the group membership database(s) 22.

One or more video camera sensors 11 may provide image capture video sequences to image processor 12 which determines the presence and frame-to-frame x, y and potentially z coordinates, i.e., (x.y,z), of persons in the surveillance scene. The camera or cameras 11 may operate in any part of the UV, visible, or IR spectrum as appropriate to the surveillance task at hand and scene illumination. The video camera sensors 11 may be fixed or steerable and may or may not utilize supplemental illumination as appropriate.

It is not necessary to know the identity of persons to track them. It may however be necessary to first determine that moving features within a scene are persons. Although this may be done in numerous ways (shape, speed, presence of legs or arms, and so forth), a very common approach of finding persons may employ a face finding algorithm that locates faces in the scene and draws a box-like boundary around each face it detects. In any given video frame, this may provide the coordinates essential for tracking (i.e., location, face size in terms of x and y for head width and height).

One approach may be to use the standoff biometric acquisition module 13 to continuously get biometric signatures from people in a scene. This module may use 2D or 3D face recognition, iris recognition, or a combination of these and/or other standoff biometric modalities.

The biometric matcher of module 14 may calculate identity match(es) with available biometrics and assign a unique temporary (TEMP) identification (ID) to each unknown person. In other words, after biometric signatures are acquired, they may be matched to signatures previously stored in the biometric database by the biometric matcher. Signatures that do not have matches in the database may automatically be enrolled in the database and given a unique ID for future use. The biometric matcher module 14 may output an ID associated with each of the subjects in the scene.

The biometric and group membership database or database module 22 may have three separate database functions that are either a part of or interact with the social activity and cluster detection, surveillance and monitoring system. These database elements may be collocated or geographically dispersed. There may be a national asset database which is envisioned to be one or more very large nationally operated military, intelligence and/or law enforcement databases which provide identity match responses to the system's nodes inquiries. The national biometric database may also continually receive new identity biometrics on as yet unidentified individuals as well as data on their associations with others and their alerting behaviors.

There may be a local collection biometric database which contains temporary identities of individuals and groups seen by the system as well as positive matches of persons seen by the surveillance system's cameras. The historical database 17 (described herein) may allow cluster(s) members to be added to the local collection database

There may be a local watchlist database which contains biometric identity data added by the surveillance system's operator or manager. This data may facilitate an alert generation when the biometric matcher module 14 output of observed identities matches the watchlist. The system's resources may be prioritized.

The history scribe module 16 may record the ID, time and location information for each subject and maintain a historical database over time. The scribe module 16 may also use individual surveillance subject's movement track dynamics and trajectories to determine that a cluster or group of persons has assembled and establish a unique identity tag for the group. The scribe's database may maintain a record of current group member identities.

The historical database 17 may provide prioritization for cluster monitoring, cluster membership dynamics, and current cluster membership dynamics. The historical database 17 may maintain a history of individual IDs, and locations over time, and also record the results of past pattern associations and inferences.

The pattern association module 18 may analyze the records in the historical database to make inferences about the activities and associations of the subjects over time. These patterns may be based on subject proximity within a scene, such as detecting when two subjects are meeting or they may be based on subject histories over time. Among the pattern associator's functions may be multiple cluster membership ID, calculating social structure of a cluster, and allowing prioritizations of previous or “key cluster member” tracking.

The system may be connected to the behavior inference and analysis sub-system or module 21. An output of the interaction pattern and association monitoring module 18 may then be passed on to processing and analyses systems, or an individual such as an analyst, that will process and analyze the patterns, make inferences about behaviors and social groupings, and take actions on the results as necessary.

FIG. 2 is a diagram of an example multi-node system showing coordinated interaction with the common biometric and group membership database 22 and the behavior inference and analysis module 21. The system node 10 described herein may be one of numerous nodes connected to the database 22 and module 21. For instance, a second node 20, and other nodes through an Nth node 30 may be connected to database 22 and module 21. Virtually all of the additional nodes may have the same structure as node 10. The interaction provides for beneficial exchanges of information among the nodes 10, 20, 30, database 22 and module 21. Each of the nodes 10, 20, 30, may have an individual two way connection 31, 32, 33, respectively, between its respective biometric matcher module 14 and the database 22. Each of the nodes 10, 20, 30, may have an individual two way connection 41, 42, 43, respectively, between its respective pattern association module 18 and the behavior inference and analysis module 21. Each of the nodes 10, 20, 30, may have a common two-way connection 34 between its respective historical database 17 and the biometric and group membership database 22. The nodes 10, 20, 30 may communicate with each other or among themselves via the connection 34. The may be other connections among the nodes 10, 20, 30. Also, there may be connections of the nodes 10, 20, 30 with outside entities besides database 22 and module 21. The outside entities may be connected to the nodes via line 34, and to line 31 through database(s) 22 and line 34.

One or more of these entities may be an access control system 44 or access control system module 44 for controlling physical security of one or more facilities. The module 44 may include one or more access control systems. An access control system 44 may provide information about identifications of individuals requesting access at various readers in the facility and the time of access. The access control system 44 may employ biometrics or other mechanisms, such as card readers, to ascertain a person's identity. This information can be used by any or all nodes 10, 20, 30 to identify and pinpoint locations of individuals at a particular time. Proximate associations between tracked individuals may be inferred from information provided by the access control system 44. One or more nodes could be connected to more than one access control system 44.

In addition or alternatively via the connection 34 database(s) 22 to the nodes, outside entities, such as an access control system 44, may be connected to nodes 10, 20, 30, and/or so on, via a connection 45 and/or line 31, 32, 33, and/or so on. Connection 45 may include the biometrics component 24 as shown for example in FIG. 1.

The present automated video-based people and crowd social activity and cluster detection and surveillance system 10, 40 may coordinate its camera functions such that individuals of unknown identity are temporarily identified (tagged) and that the other individuals and groups of individuals with which they associate are also tagged or identified and catalogued. The system may identify the formation of groups or clusters of individuals and assign an identity to the group. The system may prioritize camera operations based on which groups and/or individuals are present in the scene and or which group or individual activities are currently being observed. For instance, module 21 may receive data and information of the system 10, 20, 30 and/or network 40 from module 18 for inference and analysis of information which may lead to or provide identification of groups and members, bases of concern about the groups and members, reasons warranting surveillance and monitoring of the groups and members, and the like.

The system may use biometric matching to identify and track individuals and groups of individuals, and to determine, classify and record their behaviors in real-time. The system may provide for biometric matching against multiple remote surveillance biometric databases based on national/international databases (such as FBI and INTERPOL) and add to these the group membership and group relationship data. The system may collect multiple biometrics of unaware or non-cooperating individuals, and match the biometrics against local individual and group identity databases for rapid (real-time) evaluation and alerting, as well as match the biometrics against remote databases.

The system may track movements of individuals and groups to establish who and when group members are present in the scene. The system may provide a local watch list database for individual and/or group matching and a historical database of individual movement patterns and group dynamics of the scene.

The system may calculate the social structure of groups based on the physical and behavioral character of their placement and activity patterns. The system may provide linkage between local individual and/or group activity patterns and external behavior analysis and inference systems.

The system may provide for multiple video surveillance and biometrics capture system nodes 10, 20, 30 that cooperate as a system 40 of intelligent subsystems which behave as a network that links to a common remote biometric database and operates to track both individual and group movements across multiple camera system nodes.

The system 40 may contain or provide linkages to one or more access control systems 44 including those which employ biometrics sensors and or biometrics data and databases. The one or more nodes 10, 20, 30 may have an interface to one or more access control systems that employ biometrics and/or other technologies to provide positive identification and/or location information of subjects and/or people of interest.

In the present specification, some of the matter may be of a hypothetical or prophetic nature although stated in another manner or tense.

The present application may be related to U.S. patent application Ser. No. 11/823,166, filed Jun. 27, 2007, and U.S. patent application Ser. No. 11/343,658, filed Jan. 31, 2006. U.S. patent application Ser. No. 11/823,166, filed Jun. 27, 2007, and U.S. patent application Ser. No. 11/343,658, filed Jan. 31, 2006, are hereby incorporated by reference.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A surveillance system comprising:
a detection component;
a biometrics component connected to the detection component;
a strategy and association component connected to the detection component and the biometrics component; and
a history component connected to the biometrics component and the strategy and association component.

2. The system of claim 1, wherein:
the biometrics component and the history component are connected to a biometric and group membership database;
the strategy and association component is connected to a behavior inference and analysis module; and
the biometrics component and/or the history component are connected to one or more access control systems.

3. The system of claim 1, wherein:
the detection component is for detecting and providing coordinates of people in a scene; and
the biometrics component is for obtaining biometric signatures of the people in the scene and matching the biometric signatures to signatures previously stored in the history component.

4. The system of claim 1, wherein:
the history component is for recording an identification, time and location of detected persons, maintaining a database over time, using a movements of the persons to determine an established cluster or group of the persons, and/or establishing an identification for each cluster or group; and
the strategy and association component is for determining tracks and movement of the persons, directing under certain circumstances the detection component, analyzing records to infer activities and associations of the persons, doing multiple cluster identification, and/or calculating a social structure of the cluster or group.

5. The system of claim 1, wherein:
the detection component comprises:
at least one camera; and
a processor connected to the camera;
the biometrics component comprises:
a standoff biometric acquisition module; and
a biometric matcher module connected to the standoff biometric acquisition module;
the strategy and association component comprises:
an identity tracking strategizer module; and
a pattern association module connected to the identity tracking strategizer module; and
the history component comprises:
a history scribe module; and
a historical database connected to the history scribe module.

6. The system of claim 5, wherein:
the processor is connected to the standoff biometric acquisition module and to the identity tracking strategizer module;
the biometric matcher module is connected to the identity tracking strategizer module and to the history scribe module; and
the identity tracking strategizer module is connected to the history scribe module.

7. The system of claim 5, wherein:
the biometric matcher module and the historical database are connected to a biometric and group membership database; and
the pattern association module is connected to a behavior inference and analysis module.

8. The system of claim 7, wherein the biometric and group membership database comprises a national biometric database, a local biometric database, and/or a local watchlist.

9. The system of claim 7, wherein the behavior inference and analysis module is for inference and analysis of information which leads to identification of detected persons and their groups, bases of concern about the groups and persons, reasons warranting surveillance and/or monitoring of the groups and persons, and/or the like.

10. A social activity and cluster detection, surveillance and monitoring system comprising:
at least one video sensor;
an image processor connected to the at least one video sensor;
a standoff biometric acquisition module connected to the image processor;
a biometric matcher module connected to the standoff biometric acquisition module;
an identity tracking strategizer module connected to the image processor and the biometric matcher module; and
a pattern association module connected to the identity tracking strategizer module.

11. The system of claim 10, wherein:
the biometric matcher module is connected to a biometric and group membership database; and
the pattern association module is connected to a behavior inference and analysis module.

12. The system of claim 10, further comprising a history component connected to the biometric matcher module and the identity tracking strategizer module.

13. The system of claim 12, wherein the history component comprises:
a history scribe module; and
a historical database connected to the history scribe module.

14. The system of claim 13, wherein:
the historical database is connected to a biometric and group membership database; and
the pattern association module is connected to a behavior inference and analysis unit.

15. A surveillance and monitoring network comprising:
a plurality of system nodes;
a biometric and group membership database and/or an access control system module connected to the plurality of system nodes; and
a behavior inference and analysis module connected to the plurality of system nodes.

16. The network of claim 15, wherein each system node of the plurality of system nodes comprises:
a detection component;
a biometrics component connected to the detection component and the biometric and group membership database; and
a strategy and association component connected to the detection component, the biometrics component and the behavior inference and analysis module.

17. The network of claim 16, wherein:
the detection component comprises:
at least one camera; and
a processor connected to the at least one camera, the biometrics component and the strategy and association component;
the biometrics component comprises:
a standoff biometric acquisition module connected to the processor; and
a biometric matcher module connected to the standoff biometric acquisition module, the strategy and association component, and the biometric and group membership database; and
the strategy and association component comprises:
an identity tracking strategizer module connected to the processor and the biometric matcher module; and
a pattern association module connected to the identity tracking strategizer module and the behavior inference and analysis module.

18. The network of claim 16, further comprising a history component connected to the biometrics component, the strategy and association component, and the biometric and group membership database.

19. The network of claim 17, further comprising:
a history component connected to the biometrics component, the strategy and association component, and the biometric and group membership database; and
wherein the history component comprises:
a history scribe module connected to the biometric matcher module and the identity tracking strategizer module; and
a historical database connected to the history scribe module, the pattern association module, and the behavior inference and analysis module.

20. The system of claim 18, wherein:
the history component is for providing cluster information about detected persons as possible members of groups to the strategy and associated component;
the strategy and association component is for calculating a social structure from the cluster information; and
the behavior inference and analysis module is for inferring and analyzing information including social structure from the strategy and association component, which may lead to identification of groups and members, bases of concern about the groups and members, reasons warranting surveillance and monitoring of the groups and members, and/or the like.
